(19) United States
(12) Patent Application Publication
(10) Pub. No.: US 2009/0161910 A1
(43) Pub. Date: Jun. 25, 2009

(54) Method and Device for Reading Addresses of Mail Items

(75) Inventors: Gerhard Funcke, Konstanz (DE); Hans Fuhrmann, Konstanz (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Slemens Aktiengesellschaft

(21) Appl. No.: 12/084,095

(22) PCT Filed: Jun. 1, 2006
(86) PCT No.: PCT/EP2006/005216

§ 371 Date: Apr. 24, 2008

(30) Foreign Application Priority Data
Oct. 27, 2005 (DE) 102005051424.3

(51) Int. Cl. G06K 9/00

(52) U.S. Cl. 382/101

(57) ABSTRACT

In a method of reading addresses of mail items, images of mail item surfaces are recorded, and subjected to video encoding at video encoding stations of a video encoding facility. Distributing corresponding encoding tasks to the video encoding stations occurs in a job distribution facility. A respective encoder generates a confirmation after encoding according to specified encoding rules. At predefined time intervals, an error rate and a read rate of the video encoding facility, and, for each encoder, a current individual error rate with and without generation of the confirmation are determined, and stored in the job distribution facility. To vary the error and read rates of the video encoding facility specifically, the method specifies in the job distribution facility for the encoders performing with higher individual error rates, whether an encoding result is to be confirmed. A corresponding decision about confirmation is transmitted to the video encoding station.

The present invention relates to a method for reading the addresses of mail items as claimed in the preamble of claim 1 and a device for implementing the method as claimed in the preamble of claim 6.

Systems for the automatic reading of addresses (OCR) are well known in the field of letter processing and are described for example in DE 195 31 392 C1. With modern OCR letter sorting units it is possible to achieve processing rates of 10 letters per second, in other words 36,000 letters per hour and more. However recognition reliability varies significantly with the type of writing and overall quality of the address information on the surface of the letter. In the event of successful recognition the letter in question can be provided with a machine-readable barcode. This barcode allows further mechanical processing to any sorting order required. In particular the use of barcodes allows letters to be sorted up to the sorting level of the round sequence in which letters are sorted by the delivery operator according to their order of distribution.

Since the recognition rates of automatic reading systems vary significantly, it is necessary to back these up with video encoding facilities. In this process the video images of mail items rejected by the OCR processor are encoded manually by video encoders at corresponding video encoding stations. The input addresses are hereby converted to a sorting code by means of a directory.

In online video encoding systems (OVS) the video image is displayed to the operator, while the physical mail item is held in delay sections. In these delay sections the mail item is normally kept in motion for a period of time, which is sufficient for the operator to input the necessary sorting information for the image in question. Standard delay sections allow a delay of between 10 and 30 seconds. The longer the delay section, the higher the costs and maintenance requirements and the greater the physical size of the unit.

The main problem when using OVS is that the available time is only sufficient for careful inputting of the zipcode (ZIP) or postcode (PC), unless impractically long delay sections are used.

Special encoding methods have therefore been developed to keep the required online delay time as short as possible.

To increase encoding productivity and/or allow the indication of all address elements, i.e. ZIP/PC, street/PO box, addressee/PO box, addressee/company, the following essential methods are known:

### Preview Encoding

With preview encoding there is a simultaneous display of the images of two mail items, one above the other. The lower image is the active image, i.e. the one whose data is encoded. After suitable training it is possible for operators to encode the information on the lower image while already recording the address information from the upper image. The upper image then becomes active and the process continues. With preview encoding it is possible to double operator productivity by completely overlapping cognitive and motor functions when encoding successive images.

### Extraction Encoding

Since with the online delay times that can be achieved in practice only the ZIP/PC address elements can be reliably input by the operator, with extraction encoding specific key elements of the address component relating to the street are input. Generally extraction encoding is based on specifically developed rules, with which a code of fixed length is used as the key to access an address directory. For example the UK Royal Mail uses an extraction formula based on the first three and last two letters. Operators have to learn special rules by heart to avoid excessive address information and to take into account certain differentiating features, such as directions for example, e.g. East, West, or categories, e.g. Street, Lane, Road.

Despite being definitely effective, extraction encoding has some major disadvantages; in particular complex extraction rules, which frequently require the end of a street name to be taken into account, when these components are generally written the least clearly. There is also a significantly high rate of non-unique extractions, with which a number of entries in a directory correspond to the extraction code, so that a unique sorting decision cannot be made. It should also be noted that the input productivity of operators is reduced, as soon as they have to make decisions rather than simply making repetitive keyboard inputs.

### Offline Encoding

Since it is not possible to achieve a sufficiently high level of productivity with purely online encoding with any of the encoding techniques mentioned above, offline encoding systems are also deployed, as disclosed in US PS 49 92 649. With this system mail items with addresses that are not recognized are provided with additional information known as tracking identification (TID). The mail items that are not recognized are stored externally, while the images of said mail items are presented to operators for encoding, with no additional restrictions present. The mail items are then fed to TID read devices. The TID is linked to the input address information. Based on this it is also possible to apply standard barcode sorting information to the mail item, so the mail item in question can be processed like mail items that are OCR-read in the normal manner. Although the offline video encoding method is an effective method for encoding all address components, additional capacity is required for further processing mail items provided with unread addresses and the logistics required are complex.

A sorting system was also disclosed in U.S. Pat. No. 4,632,252 with a number of sorters, consisting of the sorting section, image recorder and OCR unit and a number of encoding stations. The data rejected in the OCR units is allocated to the video encoding stations by way of a distribution unit. The data corrected using video encoding is then sent back by way of the distribution unit to the sorters from which the rejected data originates.

Taking into account the frequency of rejected data in each sorter and the performance features of the video encoding stations, the video encoding stations are selected so that throughput is as high as possible and the encoding stations are utilized as much and as uniformly as possible. With this arrangement, with which the individual sorters and the video encoding stations are not rigidly coupled to each other, it is also possible to absorb rejection peaks at a specific sorter.

To increase read output, it is also known that all the images that have not been successfully video encoded, in other words for which the encoding does not correspond to an entry in a corresponding address dictionary, can be video encoded a second time. Only if this second attempt also fails is said image or the read result finally rejected. A current individual error rate for first-time video encoding is determined for each video encoder at specified intervals and stored in the job distribution facility. A second video encoding is only carried out for the addresses that are not video encoded successfully the first time by video encoders with the highest current individual error rates as determined according to the overall encoding error rate to be complied with, this second video encoding being carried out by video encoders with the lowest current individual error rates that are free at the time (WO 03/079273 A2).

It is also known that a confirmation key can be actuated at all video encoding stations after the complete address has been encoded, to increase encoding quality, in other words to reduce encoding errors. This allows the encoder to correct the address input after the last address character has been input. After the confirmation key has been actuated, the next image to be encoded appears on the display unit of the video encoding station. This method requires additional encoding outlay, since there is a further key actuation for each image.

The statements made regarding video encoding naturally also apply to read facilities without an automatic OCR reader.

The object of the invention specified in claims 1 and 6 is to reduce video encoding outlay for predetermined output parameters in an address read system with a number of video encoding stations.

For the method this object is achieved by the features of claim 1 and for the device by the features of claim 5.

The invention is based on the concept of configuring the requirement to actuate a confirmation key such that it can be executed separately for each video encoding station and of assigning the requirement as necessary only to the encoders with higher error rates, since only they have an appreciable chance of eliminating encoding errors by repeated checking and actuation of the confirmation key. This involves determining the error rate and read rate of the video encoding facility and the current individual error rate for each encoder with and without actuation of the confirmation key at defined time intervals and storing them in the job distribution facility.

To vary the current error and read rates of the video encoding facility specifically, it is specified respectively in the job distribution facility for the encoders with the higher individual error rates, whether the encoding result should be confirmed by actuating the confirmation key. The corresponding decision about confirmation is then transmitted to the video encoding station in question.

Advantageous embodiments of the invention are set out in the subclaims.

It is therefore advantageous if each encoder inputs a personal identifier at their video encoding station for the purpose of identification, this personal identifier being transmitted respectively to the job distribution facility.

It is also advantageous, for the purposes of verification using the encoding result, to search through an address dictionary and where there is unique assignment to an entry, to classify the encoding result as unique.

It is also advantageous, to reduce personnel outlay, to feed the stored images of the mail item surfaces showing addresses to at least one OCR unit for automatic reading of the addresses and generation of corresponding address codes and only to video encode the images in question for the first time, if the read results of the OCR read unit(s) are not unique.

In a further advantageous embodiment those encoders confirming the encoding results by means of the confirmation key are selected in such a manner that for a predetermined error rate of the video encoding facility its read rate is optimized or the error rate of the video encoding facility is minimized for a defined read rate.

The invention is now described using an exemplary embodiment with reference to a drawing, in which:

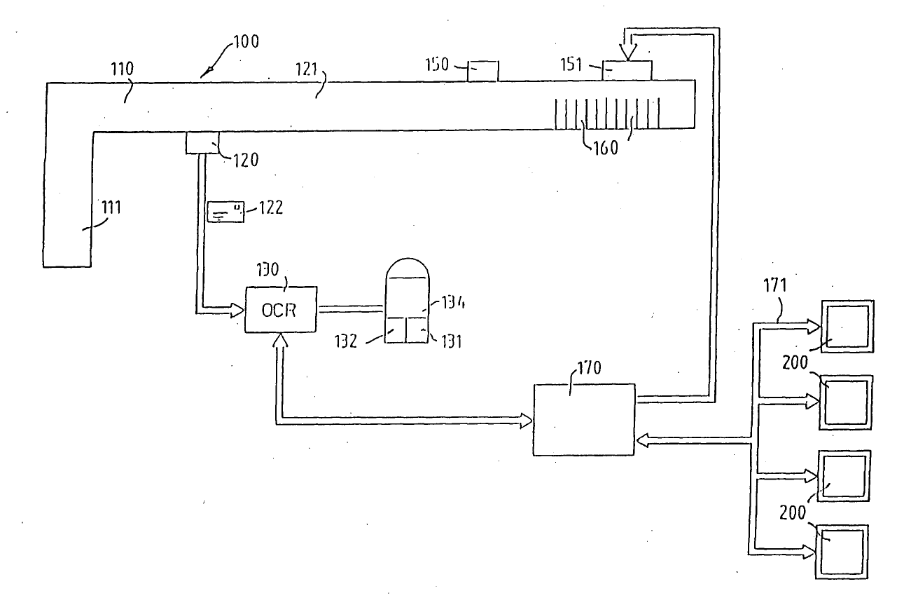

FIG. 1 shows a schematic diagram of a device for executing the method.

FIG. 1 shows a schematic diagram of a letter distribution unit, with which the inventive method can be executed. An OCR letter sorter 100 consists of a feed facility 110, which withdraws successive mail items from a magazine 111 and transports them at approx. 10 mail items per second to a high-resolution video scanner 120. The mail items are then transported in a delay section 121. The mail items generally have address information on their surface. In the OCR processor 130 the address information in the images of the mail items obtained by the video scanner 120 is analyzed. If the completed analysis is unique, a barcode printer 150 is activated and the mail item is provided with a corresponding barcode for subsequent sorting into sorting compartments 160. The OCR processor 130 consists of one or more microprocessors 131, with associated storage units 132, to store images of the mail items. The OCR processor 130 also contains an address dictionary 134 with ZIP codes, town names and street names and optionally further address-related information. During the analysis of the images containing address information, a feature-controlled reduction takes place of the entry obtained from the address dictionary 134, so that a sort of sub-dictionary is generated. In this process credibilities are assigned in individual entries, so that during the analysis a number of data items of correctly recognized addresses are generated. The device also contains a job distribution facility 170 and a number of video encoding stations 200, which are connected to the job distribution facility 170 directly or by means of a local network (LAN) 171. If the OCR analysis of an image was not successful, this image is transferred from the OCR processor 130 to the job distribution facility 170 and stored in a database there. The job distribution facility 170 on the one hand controls the TID barcode printer 151 and on the other hand sends the corresponding image to one of the video encoding stations 200. The TID barcode printer 151 applies an identification code TID to the corresponding mail item, allowing the analyzed address information to be linked to the physical mail item at a later time. In this instance the analysis of the images takes place offline, although in principle online analysis by video encoding is also possible if the delay time is sufficiently long. In the latter instance the TID can also be applied to the mail items at a later time, in other words if video encoding has not produced a complete analysis within a specific predetermined time.

After video encoding the respective result is verified with the aid of the address dictionary 134. If no correspondence can be established with the entry, the result is rejected.

In this example the job distribution facility is only connected to an OCR letter sorter 100 with OCR processor 130. It can of course also be linked to a number of OCR letter sorters.

If there is no OCR processor present, the images generated in the video scanner 120 are transmitted directly to the job distribution facility 170, stored in the database there and distributed to the video encoder stations 200. The address dictionary 134 required for verification is then part of the job distribution facility 170.

It is not possible to prevent input errors completely in a video encoding system. Depending on the quality parameters agreed for the system, certain input error rates must be complied with. To reduce the input error rate, a confirmation key can be actuated after the address has been encoded, in other words the encoder checks the result again. This reduces the error rate but throughput drops as a result, as the additional key actuation takes time.

The error rate during video encoding is determined with and without confirmation key actuation for each identified encoder at defined time intervals. This is done semi-automatically, in that for example when encoding operations are rejected (unsuccessful verification using the address dictionary) it is determined in a subsequent encoding operation whether the cause is an input error by the encoder or incorrect addressing by the sender or an incorrect entry in the address dictionary. The error rate is then determined statistically over a defined time period (see Table 1) or for a defined number of encoding operations.

Table 1 shows the determination of individual errors for 6 encoders from the number of encoding operations with and without actuation of a confirmation key in a specific time and the number of input errors and the overall error determination for the device for video encoding with all video encoding stations.

TABLE 1

| Encoder ID | A | B | C | D | E | F | Σ |
|---|---|---|---|---|---|---|---|
| Number of encoding | 1000 | 1200 | 1000 | 800 | 1000 | 1200 | 6200 |
| operations n = | | | | | | | |
| Number of encoding | 20 | 40 | 120 | 10 | 40 | 80 | 310 |
| errors without | | | | | | | |
| confirmation f1 = | | | | | | | |
| Number of encoding | 10 | 42 | 70 | 10 | 35 | 60 | 227 |
| errors with | | | | | | | |
| confirmation f2 = | | | | | | | |
| Number of relevant | 10 | −2 | 50 | 0 | 5 | 20 | 83 |
| encoding errors | | | | | | | |
| f1 − f2 = f | | | | | | | |

The function for calculating the overall error rate is:

SFR(system error rate)=((100/Σn)×(f_{A}+f_{B}+f_{C}+ . . . )

This gives a system error rate of 1.339%.

A variation equation is:

d(SFD)/d(f)=100/Σn

This allows the number of encoding errors to be calculated, which must be avoided, so that the system encoding error rate (SFD) can be changed to a specific value.

d(f)=d(SFR)×Σn/100

In this example this means:

If the system error rate SFR is to be reduced to a value of 1.0%, the previous value of 1.339% must be reduced by 0.339%. This means that

21=0.339×6200/100

Therefore at least 21 encoding errors must be avoided.

If the current system error rate SFR is known, it is possible to optimize operation, with the individual specification for each encoder whether encoding should take place with or without confirmation, so that throughput is as high as possible for example whilst still complying with the agreed system error rate.

To this end the individual relevant error rate IF f×100/n as a percentage is determined for each encoder. The corresponding values are shown in Table 2.

TABLE 2

| Encoder ID | A | B | C | D | E | F |
|---|---|---|---|---|---|---|
| IF [%] = | 1.0 | n/a | 5.0 | 0.0 | 0.50 | 1.67 |

As shown in Table 2, the encoder C should use the confirmation key, as it has the highest potential for avoiding encoding errors. If even more errors are to be avoided, encoder F with the second highest error rate would also have to confirm. In contrast it can be seen that in the cases of encoders B and D no error reduction would be achieved by using the confirmation key, in other words the result would only be a reduction in throughput.

The individual encoding error rates are constantly updated and stored in an encoding profile database.

1.-8. (canceled)

9. A method of reading addresses of mail items, comprising:
recording images of mail item surfaces showing the addresses;
subjecting the images to video encoding at a number of video encoding stations of a video encoding facility, wherein distributing corresponding encoding tasks to the video encoding stations occurs in a job distribution facility, and wherein a respective encoder generates a confirmation after encoding according to specified encoding rules;
determining at predefined time intervals an error rate and a read rate of the video encoding facility, and, for each encoder, a current individual error rate with and without generation of the confirmation;
storing the determined rates in the job distribution facility;
to vary the error and read rates of the video encoding facility specifically, specifying in the job distribution facility for the encoders performing with higher individual error rates, whether an encoding result is to be confirmed; and
transmitting a corresponding decision about confirmation to the video encoding station in question.

10. The method of claim 9, further comprising inputting a personal identifier by each encoder at the respective video encoding station, and transmitting personal identifier to the job distribution facility.

11. The method of claim 9, further comprising using the encoding result to search through an address dictionary, and classifying the encoding result as unique if there is unique assignment to an entry in the address dictionary.

12. The method of claim 9, further comprising feeding the images of the mail item surfaces to at least one optical character recognition (OCR) unit for automatic reading of the addresses and generation of corresponding address codes, wherein the images in question are only video encoded, if results of the OCR unit are not unique.

13. The method of claim 13, further comprising selecting encoders that confirm the encoding results in such a manner that for a predetermined error rate of the video encoding facility the read rate is optimized or the error rate of the video encoding facility is minimized for a defined read rate.

14. A device for reading addresses of mail items, comprising:
a device for obtaining and storing images of mail item surfaces showing the addresses;
a video encoding facility coupled to receive the images of the mail item surfaces and having a number of video encoding stations, wherein a video encoding station is configured to allow an encoder to generate a confirmation after encoding according to specified encoding rules; and
a job distribution facility configured to distribute video encoding tasks to the video encoding stations,
wherein an error rate and a read rate of the video encoding facility and a current individual error rate with and without generation of a confirmation for each encoder are determined at defined time intervals and stored in the job distribution facility,
wherein, to vary the error and read rates of the video encoding facility specifically, the job distribution facility is configured to specify for encoders with higher individual error rates, whether an encoding result is to be confirmed, and
wherein the job distribution facility is configured to transmit a corresponding decision about confirmation to the video encoding station.

15. The device of claim 14, wherein the job distribution facility is configured so that each encoder inputs a personal identifier at the respective video encoding station in order to be notified to the job distribution facility.

16. The device of claim 14, wherein an OCR processor for automatic reading addresses is coupled to the device for obtaining and storing images of mail item surfaces and to the job distribution facility.
